(19) United States
(12) Patent Application Publication
(10) Pub. No.: US 2024/0056741 A1
(43) Pub. Date: Feb. 15, 2024

(54) Sounding Device

(71) Applicant: AAC Microtech (Changzhou) Co., Ltd., Changzhou City (CN)

(72) Inventors: Dijiang Tong, Shenzhen (CN); Huanbin Liao, Shenzhen (CN); Yajian Zheng, Shenzhen (CN)

(21) Appl. No.: 18/296,973

(22) Filed: Apr. 6, 2023

Related U.S. Application Data
(63) Continuation of application No. PCT/CN2022/121721, filed on Sep. 27, 2022.

(30) Foreign Application Priority Data
Aug. 12, 2022 (CN) 202222132066.9

(51) Int. Cl. H04R 9/02; H04R 9/06; H04R 7/18

(52) U.S. Cl. CPC H04R 9/025; H04R 9/06; H04R 7/18; H04R 2400/11

(57) ABSTRACT

The present disclosure provides a sounding device, which includes a frame, a vibration system fixed on the frame and a magnetic circuit system for driving the vibration of the vibration system. The magnetic circuit system includes a magnet unit fixed on the frame and a magnetic yoke connected to the magnet unit. The sounding device also includes a plastic sealer to form multiple leak holes. The plastic sealer is opened to replace the existing breathable spacer. The sounding device of the present disclosure has smooth leakage, good acoustic performance and good user experience.

### TECHNICAL FIELD

The disclosure relates to the field of electro-acoustic transducers, in particular to a sounding device.

### BACKGROUND ART

As one of the main components of mobile terminals such as mobile phones, the sounding device is mainly used to convert electrical signals into sound signals, and is also used for earphones.

The sounding device of the related art includes a frame, a vibration system fixed on the frame, and a magnetic circuit system with the magnetic gap. The vibration system includes a diaphragm fixed to the frame for vibrating sound, a voice coil inserted into the magnetic gap to drive the diaphragm to vibrate. The frame, the vibration system and the magnetic circuit system together form an inner sounding cavity. In order to prevent dust from entering the inner sounding cavity of the sounding device, and at the same time ensure that the air leakage of the inner sounding cavity is good to balance the sound pressure, usually, the breathable spacer (Mesh) will be injection molded on the frame, or the breathable spacer will be mounted on the magnetic yoke to achieve dust and leakage.

However, in the sounding device of the related art, when the breathable spacer is injected on the frame and the breathable spacer is mounted on the magnetic yoke for leakage, the mounting efficiency of the breathable spacer is low. At the same time, due to the flexibility of the breathable spacer, only one-way leakage can be achieved, resulting in limited leakage patency, resulting in poor acoustic performance of the sounding device.

Therefore, it is necessary to provide a new sounding device to solve the above technical problems.

### SUMMARY OF THE INVENTION

The main purpose of the present disclosure is to provide the sounding device with smooth leakage and good acoustic performance.

Accordingly, the present disclosure provides a sounding device, including: a frame; a vibration system fixed on the frame; a magnetic circuit system for driving the vibration system to vibrate, including a magnet unit fixed to the frame and a magnetic yoke connected to the magnet unit; an inner sounding cavity formed by the frame, the magnetic yoke and the vibration system; and a plastic sealer which is injection-molded on the outer periphery of the magnetic yoke. The plastic sealer is penetrated to form a plurality of the leak holes connecting the inner sounding cavity with the outside of the sounding device.

As an improvement, the plastic sealer includes a bottom wall fixed to the magnetic yoke, and a side wall bent and extended from the bottom wall to the vibration system; the side wall is spaced apart from the magnet unit; the leak hole is formed through the bottom wall and/or the side wall.

As an improvement, the plurality of leak holes are arranged in an array.

As an improvement, the sounding device has a shape of a rectangle and including four plastic sealers, wherein the plastic sealers are arranged at four corners of the magnetic yoke at intervals.

As an improvement, the sounding device has a shape of a rectangle and including two plastic sealers respectively arranged at two opposite short-axis sides or two long-axis sides of the magnetic yoke.

As an improvement, the plastic sealer is annular and arranged around the periphery of the magnetic yoke.

As an improvement, the leak hole is rectangular hole, and is formed through penetrating the side wall.

As an improvement, the leak hole is a circular hole, which is formed through penetrating the bottom wall and/or the side wall.

As an improvement, the magnet unit includes a main magnet, and an auxiliary magnet arranged around the main magnet for forming a magnetic gap; the vibration system includes a diaphragm fixed on the frame, a skeleton fixed on one side of the diaphragm close to the magnetic circuit system, a dome fixed to the skeleton, and a voice coil for driving the vibration of the diaphragm; the voice coil is fixed to the skeleton and inserted into the magnetic gap; the plastic sealer surrounds the periphery of the auxiliary magnet and is spaced from the auxiliary magnet.

As an improvement, the sounding device further includes four conductive elastic members arranged at four corners of the auxiliary magnet at intervals, wherein the conductive elastic member is fixed on the skeleton and is electrically connected with the voice coil.

Compared with the related art, the sounding device of the present disclosure comprises a frame, a vibration system fixed on the frame and a magnetic circuit system which drives the vibration system to vibrate. The magnetic circuit system includes a magnet unit fixed to the frame and a magnetic yoke connected to the magnet unit. The frame, the magnetic yoke and the vibration system together form an inner sounding cavity. The sounding device also includes a plastic sealer that is injection-molded on the outer periphery of the magnetic yoke. The plastic sealer is penetrated to form a plurality of leak holes connecting the inner sounding cavity with the outside of the sounding device. The plastic sealer injected on the magnetic yoke is used for sealing and fixing, at the same time, the leak hole was opened on the plastic sealer to replace the existing breathable spacer. In this way, the breathable spacer can be omitted, saving cost, and compared with the plane leakage of the breathable spacer, the plastic opening can leak in the XYZ space, and the leakage is more smooth.

### BRIEF DESCRIPTION OF DRAWING

FIG. 1 is an isometric view of a sounding device of an embodiment of the present disclosure.

FIG. 2 is an exploded view of the sounding device in FIG. 1.

FIG. 3 is a cross-sectional view of the sounding device taken along line A-A in FIG. 1.

FIG. 4 is an enlarged view of part B in FIG. 3.

FIG. 5 is an isometric view of a sounding device of another embodiment of the present disclosure.

FIG. 6 is an exploded view of the sounding device in FIG. 5.

FIG. 7 illustrates a plastic sealer of the sounding device in FIG. 2.

FIG. 8 illustrates the plastic sealer in FIG. 2.

### DETAILED DESCRIPTION OF EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

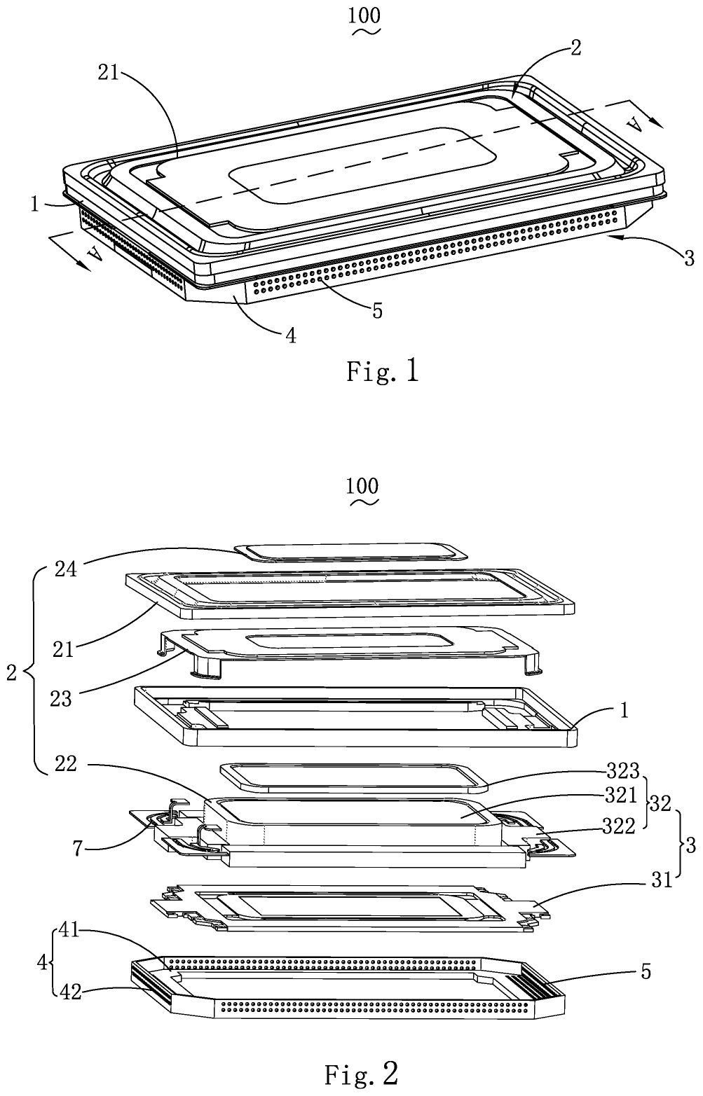

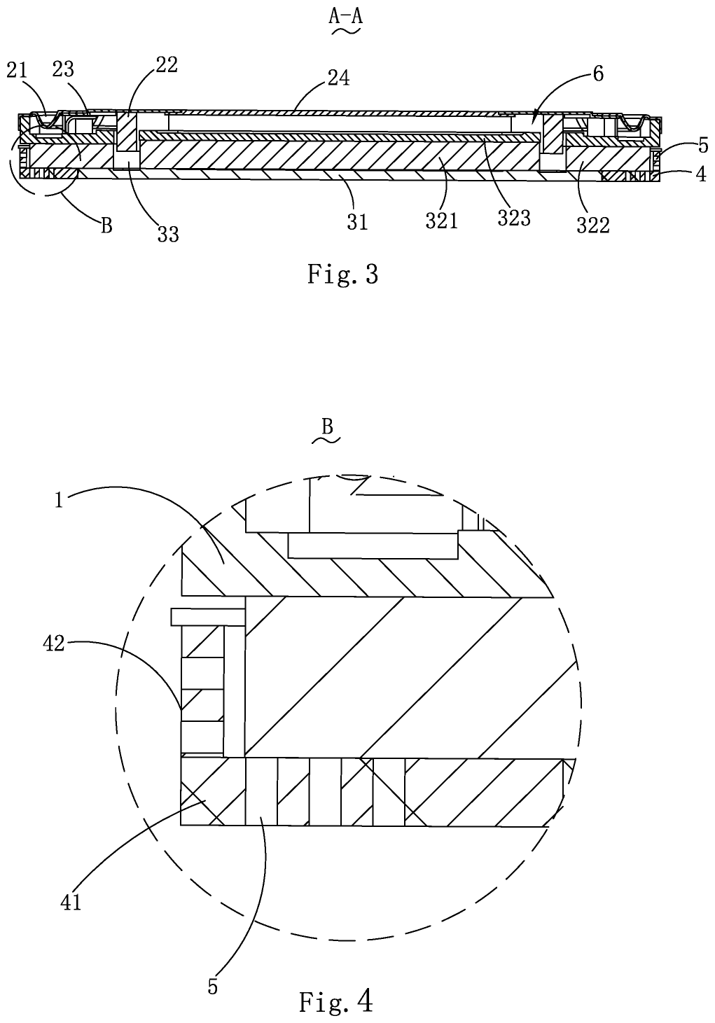

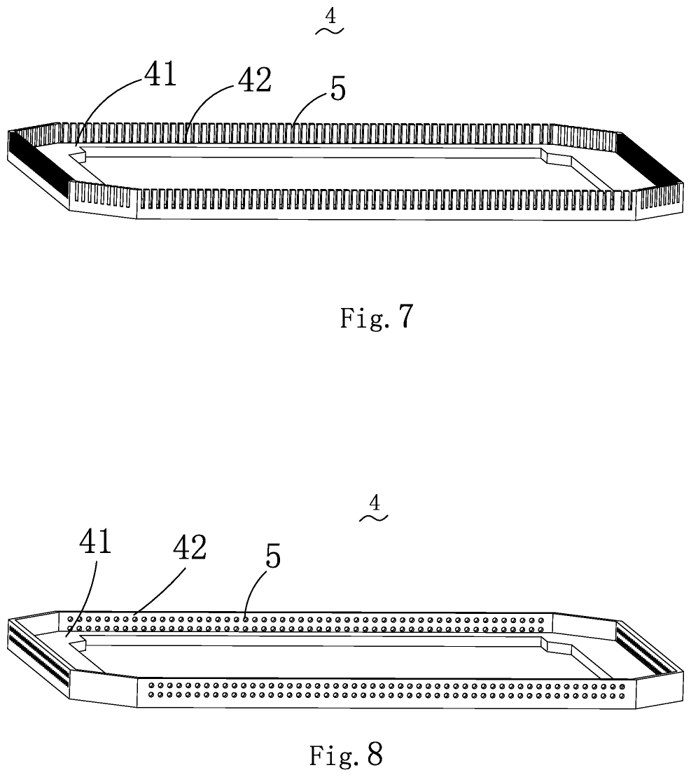

Please refer to FIGS. 1-8. One embodiment of the present disclosure provides a kind of the sounding device 100, which includes a frame 1, a vibration system 2 fixed on the frame 1 and a magnetic circuit system 3 that drives the vibration system 2 to vibrate. The magnetic circuit system 3 includes a magnet unit 32 fixed to the frame 1 and a magnetic yoke 31 connected to the magnet unit 32. The frame 1, the magnetic yoke 31 and the vibration system 2 together form an inner sounding cavity 6, the sounding device 100 also includes a plastic sealer 4 that is injection-molded on the outer periphery of the magnetic yoke 31, the plastic sealer 4 is penetrated to form a plurality of the leak holes 5 that communicate the inner sounding cavity 6 with the outside of the sounding device 100.

Specifically, the frame 1 is used to support and fix the magnetic circuit system 3 and the vibration system 2, the leak hole 5 was opened on the plastic sealer 4 to replace the existing breathable spacer, this can save the breathable spacer and save costs, moreover, compared with the plane leakage of the breathable spacer, the leakage of the plastic opening can leak in the XYZ space, and the leakage is more smooth.

In this embodiment, the magnet unit 32 includes a main magnet 321 and an auxiliary magnet 322 arranged around the main magnet 321 and spaced to form the magnetic gap 33. The vibration system 2 includes a diaphragm 21 is fixed on the frame 1, a skeleton 23 is fixed on the side of the diaphragm 21 close to the magnetic circuit system 3, a dome 24 fixed on the skeleton 23 and a voice coil 22 driving the diaphragm 21 to vibrate. The voice coil 22 is fixed to the skeleton 23 and inserted into the magnetic gap 33. The plastic sealer 4 surrounds the outer periphery of the auxiliary magnet 322 and is spaced from the auxiliary magnet 322. The magnetic field formed by the main magnet 321 and the auxiliary magnet 322 of the magnetic circuit system 3 drives the voice coil 22 to vibrate and produce sound, the effect of vibration is enhanced through the diaphragm 21, and the acoustic performance is better.

Wherein, the magnetic circuit system 3 also includes a pole core 323. The pole core 323 is attached to the main magnet 321, and the pole core 323 is set corresponding to the diaphragm 21. The voice coil 22 is sleeved on the pole core 323 and the main magnet 321. The magnetic strength of the main magnet 321 is enhanced by the pole core 323, thereby increasing the magnetic field strength of the magnetic circuit system 3, so that the sound effect of the voice coil 22 is better.

In this embodiment, the sounding device 100 further includes four conductive elastic members 7 disposed at four corners of the auxiliary magnet 322 with space. The conductive elastic member 7 is fixed on the skeleton 23 and is electrically connected to the voice coil 22. The voice coil 22 can be energized to generate sound by connecting one end of the conductive elastic member 7 with the voice coil 22 and connecting the other end with an external circuit. Optionally, the conductive elastic member 7 may be a flexible circuit board, which is easy to install and has good electrical conductivity.

In this embodiment, the plastic sealer 4 includes a bottom wall 41 fixed on the magnetic yoke 31, and a side wall 42 that is bent and extended from the bottom wall 41 to the vibration system 2. The side wall 42 is spaced apart from the magnet unit 32, and the leak hole 5 is formed through the bottom wall 41 and/or the side wall 42. The bottom wall 41 is connected with the peripheral side of the magnetic yoke 31 by injection molding, thus, the side wall 42 is formed by bending and extending from the bottom wall 41 toward the vibration system 2 for sealing. The magnet unit 32 can be protected by spacing the side wall 42 around the magnet unit 32. The bottom wall 41 and/or the side wall 42 are penetrated to form the leak holes 5, the leak holes 5 are arranged in various positions, so that the leak can be leaked in the XYZ space, the leakage is smoother, and the acoustic performance of the sounding device 100 is better.

Preferably, the bottom wall 41 and the side wall 42 are vertically arranged, and the right-angle structure formed by the bottom wall 41 and the side wall 42 is convenient to limit the position of the auxiliary magnet 322, and the fixing effect is good.

In this embodiment, a plurality of the leak holes 5 are arranged in an array. The leakage of the array arrangement is uniform, and the leakage effect is better.

As an optional embodiment, the sounding device 100 is rectangular, and the plastic sealers 4 are four in number and are respectively arranged at four corners of the magnetic yoke 31 with space. The plastic sealer 4 is fixed to the four corners of the magnetic yoke 31, and set around the auxiliary magnet 322, the auxiliary magnet 322 can be fixed. Since a leak hole 5 is provided on the plastic sealer 4, the sounding device 100 is leaked through the leak hole 5, and the acoustic performance of the sounding device 100 is good.

Preferably, the side wall 42 is penetrated to form the leak hole 5. The leak hole 5 is the rectangular hole.

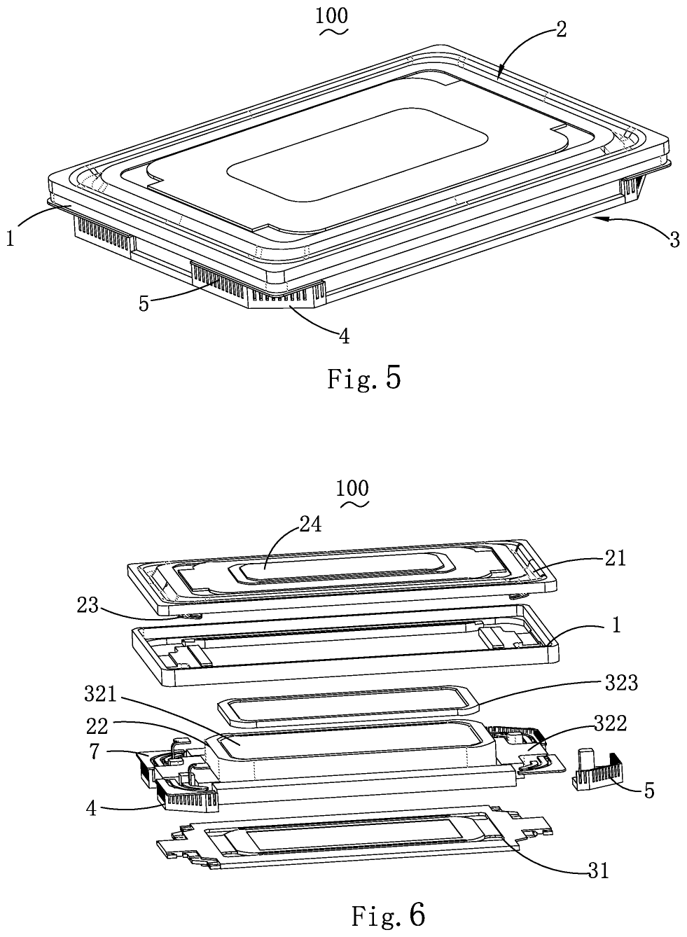

As an optional implementation, please also refer to FIGS. 5-6, the sounding device 100 is in the shape of a rectangle, and the plastic sealers 4 are two in number and are respectively disposed at two opposite short-axis sides or two long-axis sides of the magnetic yoke 31 at intervals. The leak hole 5 on the plastic sealer 4 increases by increasing the area of the plastic sealer 4, leaking effect is better.

In this embodiment, the plastic sealer 4 is annular and disposed around the periphery of the magnetic yoke 31. In this way, the fixing effect between the magnetic yoke 31 and the plastic sealer 4 is good. Since the bottom wall 41 of the plastic sealer 4 is used to support the auxiliary magnet 322, the side wall 42 is used to set the auxiliary magnet 322, the bottom wall 41 and the side wall 42 form a bent structure and are sleeved on the auxiliary magnet 322 in a whole circle, and the fixing effect of the auxiliary magnet 322 is better. Since the leak hole 5 is provided on the plastic sealer 4, the number of the leak holes 5 is increased by increasing the area of the plastic sealer 4, thereby improving the leakage of the inner sounding cavity 6 in the sounding device 100 more smoothly.

In this embodiment, the leak hole 5 is the rectangular hole, and is formed through the side wall 42. The rectangular hole is arranged in a large area, and the leakage is smooth.

In this embodiment, the leak hole 5 is a circular hole, and is formed through penetration of the bottom wall 41 and/or the side wall 42. The circular holes are distributed more and evenly, and the leakage effect is even.

Compared with the related art, the sounding device of the present disclosure comprises a frame, a vibration system fixed on the frame and a magnetic circuit system which drives the vibration system to vibrate. The magnetic circuit system includes a magnet unit fixed to the frame and a magnetic yoke connected to the magnet unit. The frame, the magnetic yoke and the vibration system together form the inner sounding cavity. The sounding device further comprises a plastic sealer which is injection-molded on the outer periphery of the magnetic yoke. The plastic sealer is penetrated to form a plurality of leak holes connecting the inner sounding cavity with the outside of the sounding device. The plastic sealer injected on the magnetic yoke is used for sealing and fixing, at the same time, the leak hole was opened on the plastic sealer to replace the existing breathable spacer. In this way, the breathable spacer can be omitted, saving cost, and compared with the plane leakage of the breathable spacer, the plastic opening can leak in the XYZ space, and the leakage is more smooth.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A sounding device, including:
a frame;
a vibration system fixed on the frame;
a magnetic circuit system for driving the vibration system to vibrate, including a magnet unit fixed to the frame and a magnetic yoke connected to the magnet unit;
an inner sounding cavity formed by the frame, the magnetic yoke and the vibration system;
a plastic sealer which is injection-molded on an outer periphery of the magnetic yoke; wherein
the plastic sealer is penetrated to form a plurality of the leak holes connecting the inner sounding cavity with an outside of the sounding device.

2. The sounding device as described in claim 1, wherein the plastic sealer includes a bottom wall fixed to the magnetic yoke, and a side wall bent and extended from the bottom wall to the vibration system; the side wall is spaced apart from the magnet unit; the leak hole is formed through the bottom wall and/or the side wall.

3. The sounding device as described in claim 2, wherein the plurality of leak holes are arranged in an array.

4. The sounding device as described in claim 2, having a shape of a rectangle and including four plastic sealers, wherein the plastic sealers are arranged at four corners of the magnetic yoke at intervals.

5. The sounding device as described in claim 2, having a shape of a rectangle and including two plastic sealers respectively arranged at two opposite short-axis sides or two long-axis sides of the magnetic yoke.

6. The sounding device as described in claim 1, wherein the plastic sealer is annular and arranged around the periphery of the magnetic yoke.

7. The sounding device as described in claim 2, wherein the leak hole is rectangular hole, and is formed through penetrating the side wall.

8. The sounding device as described in claim 2, wherein the leak hole is a circular hole, which is formed through penetrating the bottom wall and/or the side wall.

9. The sounding device as described in claim 1, wherein the magnet unit includes a main magnet, and an auxiliary magnet arranged around the main magnet for forming a magnetic gap; the vibration system includes a diaphragm fixed on the frame, a skeleton fixed on one side of the diaphragm close to the magnetic circuit system, a dome fixed to the skeleton, and a voice coil for driving the vibration of the diaphragm; the voice coil is fixed to the skeleton and inserted into the magnetic gap; the plastic sealer surrounds the periphery of the auxiliary magnet and is spaced from the auxiliary magnet.

10. The sounding device as described in claim 9, further including four conductive elastic members arranged at four corners of the auxiliary magnet at intervals, wherein the conductive elastic member is fixed on the skeleton and is electrically connected with the voice coil.
